(19) United States
(12) Patent Application Publication
(10) Pub. No.: US 2025/0181376 A1
(43) Pub. Date: Jun. 5, 2025

(54) STORAGE DEVICE CONTROL METHOD AND APPARATUS, ELECTRONIC DEVICE, AND STORAGE MEDIUM

(71) Applicant: Beijing Volcano Engine Technology Co., Ltd., Beijing (CN)

(72) Inventors: Zhengyi LU, Beijing (CN); Liang ZHOU, Beijing (CN); Yibo ZHOU, Beijing (CN); Xianming LI, Beijing (CN)

(21) Appl. No.: 18/908,323

(22) Filed: Oct. 7, 2024

(30) Foreign Application Priority Data
Dec. 1, 2023 (CN) 202311642674.7

(51) Int. Cl. G06F 9/455; G06F 9/4401

(52) U.S. Cl. CPC G06F 9/45558; G06F 9/4411; G06F 2009/45583

(57) ABSTRACT

Embodiments of the present disclosure provide a storage device control method and apparatus, an electronic device, and a storage medium. The method includes: obtaining virtualization mapping information of a target physical device by accessing an extended base address register space, where the virtualization mapping information is used to implement a pass-through connection between a virtual machine client and the target physical device, and the target physical device is a storage device that is mounted on a virtual machine host corresponding to the virtual machine client; and operating, based on the virtualization mapping information, the target physical device in response to a first operation request for a target virtual device, to obtain an operation result, where the target virtual device is a virtualization device corresponding to the target physical device and created in the virtual machine client.

### CROSS-REFERENCE TO RELATED APPLICATIONS

This application claims priority to Chinese Patent Application No. 202311642674.7, filed on Dec. 1, 2023 and entitled “STORAGE DEVICE CONTROL METHOD AND APPARATUS, ELECTRONIC DEVICE, AND STORAGE MEDIUM”, which is hereby incorporated by reference in its entirety.

### TECHNICAL FIELD

Embodiments of the present disclosure relate to the field of cloud computing technologies, and in particular, to a storage device control method and apparatus, an electronic device, and a storage medium.

### BACKGROUND

Currently, in a cloud computing scenario, a local storage device that is mounted on a virtual machine host is provided for a virtual machine client to use, to reduce a storage cost of the virtual machine client.

In the prior art, when the virtual machine client uses the storage device that is mounted on the virtual machine host, there are problems of increasing a running load on the virtual machine host and reducing data access efficiency.

### SUMMARY

Embodiments of the present disclosure provide a storage device control method and apparatus, an electronic device, and a storage medium, to overcome the problems of increasing a running load on a virtual machine host and reducing data access efficiency.

In a first aspect, an embodiment of the present disclosure provides a storage device control method, including:
obtaining virtualization mapping information of a target physical device by accessing an extended base address register space, wherein the virtualization mapping information is used to implement a pass-through connection between a virtual machine client and the target physical device, and the target physical device is a storage device that is mounted on a virtual machine host corresponding to the virtual machine client; and operating, based on the virtualization mapping information, the target physical device in response to a first operation request for a target virtual device, to obtain an operation result, wherein the target virtual device is a virtualization device corresponding to the target physical device and created in the virtual machine client.

In a second aspect, an embodiment of the present disclosure provides a storage device control apparatus, including:
an obtaining module, configured to obtain virtualization mapping information of a target physical device by accessing an extended base address register space, wherein the virtualization mapping information is used to implement a pass-through connection between a virtual machine client and the target physical device, and the target physical device is a storage device that is mounted on a virtual machine host corresponding to the virtual machine client; and
an operation module, configured to operate, based on the virtualization mapping information, the target physical device in response to a first operation request for a target virtual device, to obtain an operation result, wherein the target virtual device is a virtualization device corresponding to the target physical device and created in the virtual machine client.

In a third aspect, an embodiment of the present disclosure provides an electronic device, including: a processor and a memory;
the memory stores a computer-executable instruction; and
the processor executes the computer-executable instruction stored in the memory, to enable the at least one processor to perform the storage device control methods according to the first aspect and the various possible designs of the first aspect.

In a fourth aspect, an embodiment of the present disclosure provides a computer-readable storage medium, wherein the computer-readable storage medium stores a computer-executable instruction, and when a processor executes the computer-executable instruction, the storage device control methods according to the first aspect and the various possible designs of the first aspect are implemented.

In a fifth aspect, an embodiment of the present disclosure provides a computer program product, including a computer program, wherein when the computer program is executed by a processor, the storage device control methods according to the first aspect and the various possible designs of the first aspect is implemented.

According to the storage device control method and apparatus, the electronic device, and the storage medium that are provided in the embodiments of the present disclosure, the extended base address register space is accessed, to obtain the virtualization mapping information of the target physical device, where the virtualization mapping information is used to implement the pass-through connection between the virtual machine client and the target physical device, and the target physical device is a storage device that is mounted on a virtual machine host corresponding to the virtual machine client; and in response to the first operation request for the target virtual device, the target physical device is operated based on the virtualization mapping information, to obtain the operation result, where the target virtual device is a virtualization device corresponding to the target physical device and created in the virtual machine client. By transmitting the virtualization mapping information of the target physical device to the virtual machine client, the virtual machine client can implement the pass-through connection with the target physical device that is mounted on the virtual machine host based on the virtualization mapping information, to reduce a running load on the virtual machine host and improve data access efficiency between the virtual machine client and the physical device.

### BRIEF DESCRIPTION OF THE DRAWINGS

To describe the technical solutions in the embodiments of the present disclosure or in the prior art more clearly, the following briefly describes the accompanying drawings used in describing the embodiments or the prior art. Apparently, the accompanying drawings in the following description show some embodiments of the present disclosure, and a person of ordinary skill in the art may still derive other drawings from these accompanying drawings without creative efforts.

FIG. 1 is a diagram of an application scenario of a storage device control method according to an embodiment of the present disclosure.

FIG. 2 is a schematic flowchart 1 of a storage device control method according to an embodiment of the present disclosure.

FIG. 3 is a flowchart of a specific implementation of step S102 in the embodiment shown in FIG. 2.

FIG. 4 is a schematic diagram of a process of a virtual machine client controlling a target physical device according to an embodiment of the present disclosure.

FIG. 5 is a schematic flowchart 2 of a storage device control method according to an embodiment of the present disclosure.

FIG. 6 is a flowchart of a specific implementation of step S205 in the embodiment shown in FIG. 5.

FIG. 7 is a flowchart of a specific implementation of step S207 in the embodiment shown in FIG. 5.

FIG. 8 is a schematic diagram of a process of controlling a target physical device according to an embodiment of the present disclosure.

FIG. 9 is a structural block diagram of a storage device control apparatus according to an embodiment of the present disclosure.

FIG. 10 is a structural schematic diagram of an electronic device according to an embodiment of the present disclosure.

FIG. 11 is a schematic diagram of a hardware structure of an electronic device according to an embodiment of the present disclosure.

### DESCRIPTION OF EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It should be noted that the user information (including but not limited to user device information, user personal information, and the like) and data (including but not limited to data for analysis, stored data, displayed data, and the like) involved in the present disclosure are information and data authorized by the user or fully authorized by all parties. In addition, the collection, use, and processing of related data need to comply with related laws, regulations, and standards of corresponding countries and regions, and corresponding operation entrances are provided for the user to choose to authorize or refuse.

An application scenario of the embodiments of the present disclosure is described below.

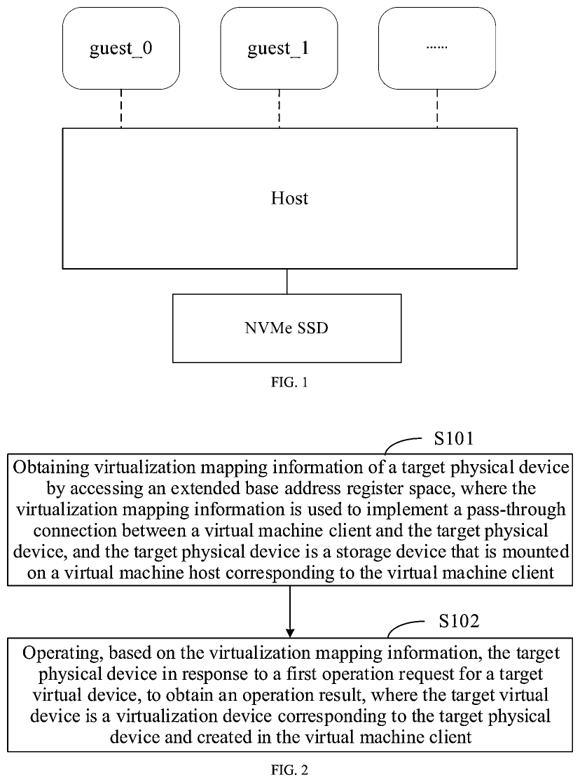

FIG. 1 is a diagram of an application scenario of a storage device control method according to an embodiment of the present disclosure. The storage device control method provided in this embodiment of the present disclosure may be applied to an application scenario such as cloud computing or cloud service. More specifically, the method may be applied to a process in which a virtual machine client (guest) accesses a non-volatile memory express solid state disk (NVMe SSD) mounted on a virtual machine host (host) in a private cloud scenario. An execution subject of this embodiment may be a terminal device or a server running the virtual machine client, or another electronic device with a similar function. With reference to FIG. 1, a plurality of virtual machine clients (guests), for example, including a virtual machine client guest_0, a virtual machine client guest_1, and the like shown in the figure are created on a virtual machine host (host) deployed in a cloud server. A virtual machine client refers to a complete computer system that is simulated by software, has functions of a complete hardware system and runs in an isolated environment. A physical storage device, for example, an NVMe SSD, is mounted on a side of the cloud server in which the virtual machine host is deployed. The virtual machine client may control the physical storage device, for example, read or write data, through a control instruction, to implement the purpose of using, by the virtual machine client, the storage device that is mounted on the virtual machine host. With the foregoing solution, flexible adjustment of hardware resources provided for the virtual machine client can be implemented, and a maintenance and adjustment cost of the entire virtual machine system is reduced.

In the prior art, when the virtual machine client needs to use the physical storage device, the support of computing resources needs to be provided by the virtual machine host. For example, after the virtual machine client submits a data access request, the virtual machine client interacts with the physical storage device through a software running on the virtual machine client. In this case, the virtual machine host needs to consume an additional thread to process the data access, thereby resulting in additional computing resource consumption on the virtual machine host, and causing a time delay in a data processing process. That is, the problems of increasing a running load on the virtual machine host and reducing data access in efficiency are caused.

An embodiment of the present disclosure provides a storage device control method to solve the foregoing problems.

With reference to FIG. 2, FIG. 2 is a schematic flowchart 1 of a storage device control method according to an embodiment of the present disclosure. The method in this embodiment may be applied to a terminal device or a server running a virtual machine client. The storage device control method includes the following steps.

Step S101: obtaining virtualization mapping information of a target physical device by accessing an extended base address register space, where the virtualization mapping information is used to implement a pass-through connection between a virtual machine client and the target physical device, and the target physical device is a storage device that is mounted on a virtual machine host corresponding to the virtual machine client.

Step S102: operating, based on the virtualization mapping information, the target physical device in response to a first operation request for a target virtual device, to obtain an operation result, where the target virtual device is a virtualization device corresponding to the target physical device and created in the virtual machine client.

For example, with reference to a schematic diagram of an application scenario shown in FIG. 1, after a virtual machine host creates a virtual machine client (instance), the virtual machine client runs as a complete computer system. The virtual machine client is provided with a target virtual device, for example, a virtualized disk. When the target virtual device needs to store data in or read data from the virtualized disk based on a user instruction or a program execution logic, the target virtual device receives or generates a first operation request. The first operation request is for the target virtual device. However, based on an implementation principle of the virtual machine, final operation data is written into or read from a target physical device.

Further, when responding to the first operation request for the target virtual device, the virtual machine client needs to use the virtualization mapping information of the target physical device to implement a data write operation or a data read operation on the target physical device, where the virtualization mapping information is used to implement the pass-through connection between the virtual machine client and the target physical device, so that when the virtual machine client controls the virtualization mapping information, the virtual machine host is not required to process the first operation request.

Further, the virtualization mapping information is stored in the extended base address register space. The virtual machine client accesses the extended base address register space to obtain the virtualization mapping information of the target physical device, and then responds to the first operation request based on the virtualization mapping information. A base address register (Base Address Register, BAR) is a concept in a peripheral component interconnect express (PCIE) standard, and is located in a configuration space (Configuration Space). The base address register is used to determine a size of a system memory space required by a function, and provide a base address for mapping to a function memory space. A space corresponding to each base address register is a base address register space. An operating system or a function program of the virtual machine host can set content in the base address register. A specific implementation and an operation method of the base address register are the prior art, and are not described herein again. The extended base address register space in this embodiment may be understood as a bar that is custom-set in the configuration space, and more specifically, for example, is bar5 (that is, the fifth base address register in the configuration space), that is, an extended base address register identifier. Access to the extended base address register space of the target virtual device can be implemented through the extended base address register identifier. The virtualization mapping information is stored in the custom base address register space and sent to the virtual machine client, so that the virtual machine client can obtain the virtualization mapping information of the target physical device, to implement the pass-through connection between the virtual machine client and the target physical device. In this way, the virtual machine client directly controls and operates the target physical device to obtain the operation result, for example, an identifier indicating that the target physical device successfully stores data, or specific data read from the target physical device.

Further, in a possible implementation, as shown in FIG. 3, a specific implementation of step S102 includes the following steps.

Step S1021: converting, based on the virtualization mapping information, the first operation request into a second operation request for the target physical device.

Step S1022: sending the second operation request to the target physical device, to operate the target physical device and obtain the operation result returned by the target physical device.

For example, the virtualization mapping information is obtained, and based on the virtualization mapping information, the first operation request for the virtual device is converted into the second operation request for the physical device (that is, IO submission of the virtual disk is converted into IO submission of the physical disk), to implement pass-through control of the physical device without participation of the virtual machine host.

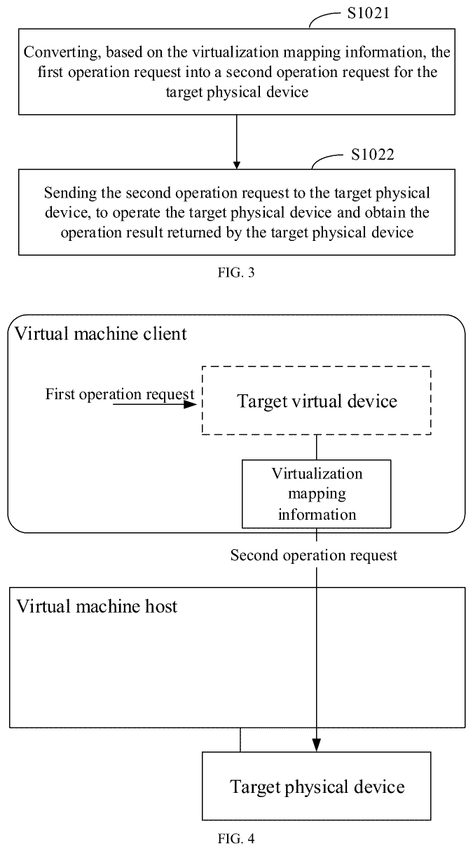

FIG. 4 is a schematic diagram of a process of a virtual machine client controlling a target physical device according to an embodiment of the present disclosure. The foregoing process is described in more detail below with reference to FIG. 4. As shown in FIG. 4, first, after a virtual machine client is initialized, a target virtual device corresponding to a target physical device is created. Then, the virtual machine client accesses an extended base address register space of the target virtual device to obtain virtualization mapping information. Next, after receiving a first operation request for the target virtual device, the virtual machine client converts the first operation request into a second operation request by using the virtualization mapping information, and sends the second operation request to the target physical device, to operate the target physical device and implement a pass-through connection between the virtual machine client and the target physical device.

In this embodiment, the extended base address register space is accessed, to obtain the virtualization mapping information of the target physical device, where the virtualization mapping information is used to implement the pass-through connection between the virtual machine client and the target physical device, and the target physical device is a storage device that is mounted on a virtual machine host corresponding to the virtual machine client; and based on the virtualization mapping information, the target physical device is operated in response to the first operation request for the target virtual device, to obtain the operation result, where the target virtual device is a virtualization device corresponding to the target physical device and created in the virtual machine client. By transmitting the virtualization mapping information of the target physical device to the virtual machine client, the virtual machine client can implement the pass-through connection with the target physical device that is mounted on the virtual machine host based on the virtualization mapping information, to reduce a running load on the virtual machine host and improve data access efficiency between the virtual machine client and the physical device.

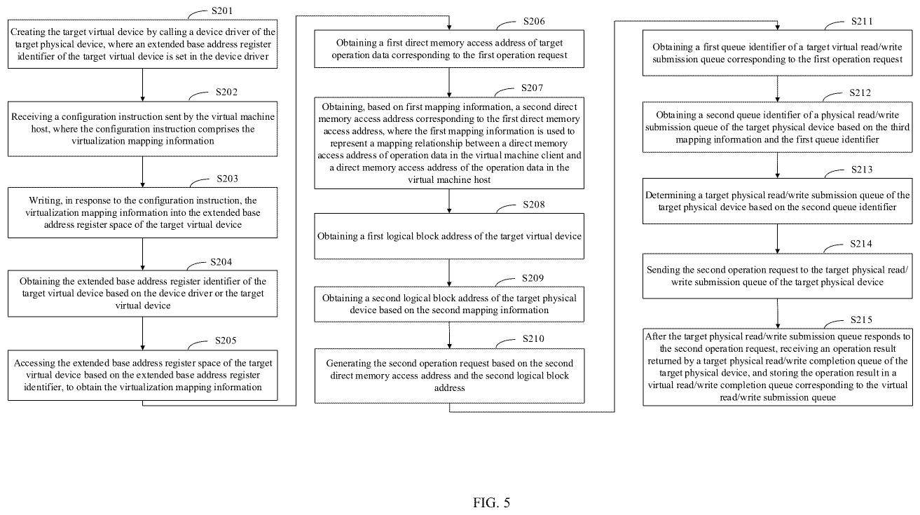

With reference to FIG. 5, FIG. 5 is a schematic flowchart 2 of a storage device control method according to an embodiment of the present disclosure. On the basis of the embodiment shown in FIG. 2, this embodiment further refines steps S101 to S102. Exemplarily, the virtualization mapping information includes at least one of first mapping information, second mapping information, and third mapping information. The storage device control method includes the following steps.

Step S201: creating the target virtual device by calling a device driver of the target physical device, where an extended base address register identifier of the target virtual device is set in the device driver.

Step S202: receiving a configuration instruction sent by the virtual machine host, where the configuration instruction comprises the virtualization mapping information.

Step S203: writing, in response to the configuration instruction, the virtualization mapping information into the extended base address register space of the target virtual device.

For example, the virtual machine client creates the target virtual device by calling the device driver (for example, an nvme driver) of the target physical device. In addition, the virtual machine client receives the configuration instruction sent by the virtual machine host, where the configuration instruction includes the virtualization mapping information corresponding to the target physical device. The virtual machine client writes the virtualization mapping information into the extended base address register space of the target virtual device. The foregoing process may be an initialization process of the target virtual device or the target physical device. In other words, in the initialization process of the target virtual device or the target physical device, the virtual machine host that mounts with the target physical device transmits the virtualization mapping information of the target physical device to the virtual machine client and stores the virtualization mapping information in a specified location (the extended base address register space).

Step S204: obtaining the extended base address register identifier of the target virtual device based on the device driver or the target virtual device.

Step S205: accessing the extended base address register space of the target virtual device based on the extended base address register identifier, to obtain the virtualization mapping information.

For example, an interface provided by the device driver is then accessed, or an attribute of the target virtual device is accessed, to obtain the extended base address register identifier of the target virtual device, where the extended base address register identifier is an identification identifier of a base address register identifier, and is used to distinguish between different base address register identifiers. For example, the extended base address register identifier is BAR5 or a virtual address of an extended base address register.

For example, as shown in FIG. 6, a specific implementation of step S205 includes the following steps.

Step S2051: calling an input/output remapping method by using the extended base address register identifier as an input parameter, to obtain an address of the extended base address register space of the target virtual device.

Step S2052: accessing the address of the extended base address register space to obtain the virtualization mapping information.

For example, an input/output remapping method, i.e., ioremap( ) is a function in the Linux kernel, and is used to map a physical address to a virtual address space of the kernel. For the ioremap function, when a virtual address addr and a physical address, that is, a register address (an incoming parameter) are known, a mapping function is directly called to program a memory management unit (MMU), to implement a mapping relationship between the addr and the register address. Specific parameters, an implementation, and a calling manner of the ioremap function are the prior art, and are not described herein again. By calling the input/output remapping method by using the extended base address register identifier as the input parameter, the address of the extended base address register space of the target virtual device can be obtained, and then the address of the extended base address register space is accessed, to obtain the virtualization mapping information stored in the extended base address register space.

Step S206: obtaining a first direct memory access address of target operation data corresponding to the first operation request.

Step S207: obtaining, based on first mapping information, a second direct memory access address corresponding to the first direct memory access address, where the first mapping information is used to represent a mapping relationship between a direct memory access address of operation data in the virtual machine client and a direct memory access address of the operation data in the virtual machine host.

For example, a direct memory access (DMA) address is also referred to as a DMA memory address. Direct memory access is a fast data transmission technology for implementing direct access, by an input/output (I/O) device, to a memory, and the DMA address refers to a memory address, of operation data, that is accessed by the DMA. The first direct memory access address in this embodiment is a virtual address corresponding to the target virtual device before conversion, and the second direct memory access address obtained after conversion by using the first mapping information is a direct memory access address in the virtual machine host. The mapping of the DMA address is implemented by using the first mapping information. This process is also referred to as DMA remapping.

In this embodiment, the direct memory access address (the first direct memory access address) corresponding to the target virtual device is mapped to the direct memory access address (the second direct memory access address) in the virtual machine host by using the first mapping information, to implement the DMA remapping process. Since this step is performed on the virtual machine client side, additional computing resource overhead on the virtual machine host can be reduced, and resource consumption on the virtual machine host is reduced.

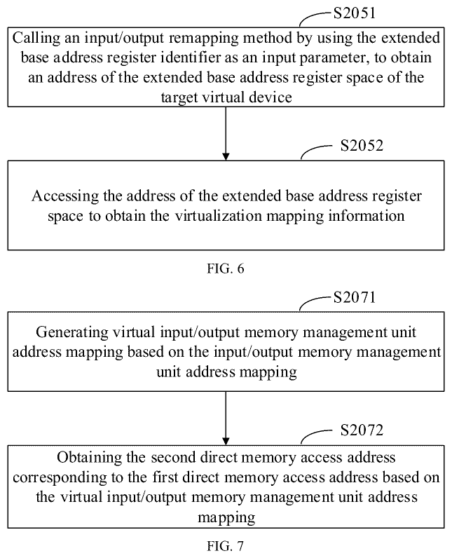

For example, further, the first mapping information includes input/output memory management unit (IOMMU) address mapping. As shown in FIG. 7, a specific implementation of step S207 includes the following steps.

Step S2071: generating virtual input/output memory management unit address mapping based on the input/output memory management unit address mapping.

Step S2072: obtaining the second direct memory access address corresponding to the first direct memory access address based on the virtual input/output memory management unit address mapping.

For example, the first mapping information includes IOMMU page table information. The IOMMU is an input/output device memory management unit, and is configured to connect a direct memory access-capable I/O bus and a main memory. The IOMMU is configured to convert a virtual address accessed by a physical device into a physical address. The IOMMU allows a virtual device to perform addressing in a virtual memory, that is, maps a virtual memory address to a physical memory address, so that the physical device can work in a virtual memory environment (namely, the virtual machine client). After the IOMMU page table information is transmitted to the virtual machine client, the virtual machine client constructs corresponding virtual input/output memory management unit (VIOMMU) address mapping, that is, VIOMMU page table information, after obtaining related information. The VIOMMU is an IOMMU function running in the virtual machine client, and is configured to convert a virtual memory address accessed by the target virtual device into a corresponding physical memory address. Then, the first direct memory access address is mapped to the corresponding second direct memory access address, that is, the direct memory access address of the target physical device in the virtual machine host, based on the virtual input/output memory management unit address mapping.

Further, in an implementation, in a possible implementation, the second direct memory access address is obtained, and combined with other preset information, for example, an nid, a qid, an slba, etc. of the target physical device, to generate the second operation request based on the second direct memory access address.

In another possible implementation, the virtualization mapping information includes second mapping information, and the second mapping information is used to represent a mapping relationship between a logical block address of the virtual device and a logical block address of the physical device. The method further includes the following steps.

Step S208: obtaining a first logical block address of the target virtual device.

Step S209: obtaining a second logical block address of the target physical device based on the second mapping information.

Step S210: generating the second operation request based on the second direct memory access address and the second logical block address.

For example, the first logical block address (LBA) of the target virtual device is further obtained, where the logical block address (LBA) may be an address of a specific data block or a data block pointed to by a specific address. The first logical block address corresponding to the target virtual device is a virtual address in a virtual machine client environment, and is converted, by using the second mapping information, into the second logical block address corresponding to the target physical device, that is, an actual physical address. This process is an I/O translation process. Then, the second operation request is generated based on the second direct memory access address and the second logical block address.

In an implementation, in a possible implementation, the virtualization mapping information further includes third mapping information, and the third mapping information is used to represent a mapping relationship between a queue identifier of the physical device and a queue identifier of the virtual device.

Correspondingly, the method in this embodiment further includes the following steps.

Step S211: obtaining a first queue identifier of a target virtual read/write submission queue corresponding to the first operation request.

Step S212: obtaining a second queue identifier of a physical read/write submission queue of the target physical device based on the third mapping information and the first queue identifier.

Step S213: determining a target physical read/write submission queue of the target physical device based on the second queue identifier.

Step S214: sending the second operation request to the target physical read/write submission queue of the target physical device.

Step S215: after the target physical read/write submission queue responds to the second operation request, receiving an operation result returned by a target physical read/write completion queue of the target physical device, and storing the operation result in a virtual read/write completion queue corresponding to the virtual read/write submission queue.

For example, the virtual read/write submission queue in this embodiment, i.e., a virtual IO submission queue (VIOSQ), is a virtual queue corresponding to the target virtual device and used for submitting a data request in the virtual machine client environment. The virtualization mapping information further includes third mapping information representing a mapping relationship between a queue identifier (Queue ID, qid) of the physical device and a queue identifier of the virtual device. Through the third mapping information, mapping between a read/write submission queue of the target virtual device and a physical read/write submission queue (IO Submission Queue, IOSQ) of the target physical device can be implemented, to implement the pass-through connection between the target virtual device and the target physical device. Specifically, after obtaining the third mapping information through the extended base address register space, the virtual machine client maps, based on the third mapping information, a first queue identifier (qid) of a virtual read/write submission queue (VIOSQ) corresponding to the target virtual device that is indicated by the first operation request, to a corresponding second queue identifier, and then determines the target physical read/write submission queue (IOSQ) of the target physical device based on the second queue identifier.

Then, the second operation request is sent to the target physical read/write submission queue of the target physical device, and the target physical read/write submission queue performs queue processing on the second operation request in sequence. After the target physical read/write submission queue responds to the second operation request, a corresponding operation result is generated and stored in a corresponding target physical read/write completion queue (IO Completion Queue, IOCQ). Then, the target physical read/write completion queue sends the operation result to a target virtual read/write completion queue (Virtual IO Completion Queue, VIOCQ) in the target virtual device for storage, to complete the purpose of returning the operation result to the virtual machine client. The physical read/write submission queue and the physical read/write completion queue are task queues in the virtual machine client environment, and are located in a memory of the virtual machine client.

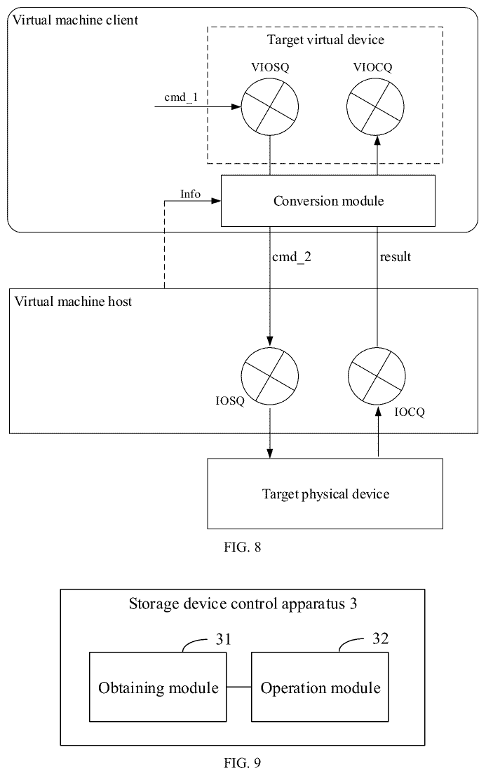

FIG. 8 is a schematic diagram of a process of controlling a target physical device according to an embodiment of the present disclosure. The foregoing process is described below with reference to FIG. 8. As shown in FIG. 8, after obtaining the virtualization mapping information sent by the virtual machine host, the virtual machine client sends a first operation request cmd_1 (shown as cmd_1 in the figure) to a virtual read/write submission queue VIOSQ in response to an instruction entered by a user. Then, the virtual read/write submission queue converts the first operation request cmd_1 into a second operation request cmd_2 (shown as cmd_2 in the figure) through a conversion module, and sends the second operation request cmd_2 to a physical read/write submission queue IOSQ in the target physical device. The conversion module obtains virtualization mapping information Info (shown as Info in the figure), and converts the first operation request cmd_1 into the second operation request cmd_2 based on the virtualization mapping information Info. Then, the physical read/write submission queue IOSQ responds to the second operation request cmd_2, and operates the target physical device, for example, writes operation data, and an operation result result (shown as result in the figure) is sent to a physical read/write completion queue IOCQ after the operation result result is processed by the target physical device. Then, the physical read/write completion queue IOCQ returns the operation result result to a virtual read/write completion queue VIOCQ corresponding to the target virtual device, to implement the process of returning the operation result to the virtual machine client.

Corresponding to the storage device control method in the foregoing embodiment, FIG. 9 is a structural block diagram of a storage device control apparatus according to an embodiment of the present disclosure. For ease of description, only parts related to the embodiments of the present disclosure are shown. Referring to FIG. 9, a storage device control apparatus 3 includes:
an obtaining module 31, configured to obtain virtualization mapping information of a target physical device by accessing an extended base address register space, where the virtualization mapping information is used to implement a pass-through connection between a virtual machine client and the target physical device, and the target physical device is a storage device that is mounted on a virtual machine host corresponding to the virtual machine client; and
an operation module 32, configured to operate, based on the virtualization mapping information, the target physical device in response to a first operation request for a target virtual device, to obtain an operation result, where the target virtual device is a virtualization device corresponding to the target physical device and created in the virtual machine client.

In an embodiment of the present disclosure, the obtaining module 31 is specifically configured to: obtain an extended base address register identifier of the target virtual device; and access the extended base address register space of the target virtual device based on the extended base address register identifier, to obtain the virtualization mapping information.

In an embodiment of the present disclosure, when accessing the extended base address register space of the target virtual device based on the extended base address register identifier, to obtain the virtualization mapping information, the obtaining module 31 is specifically configured to: call an input/output remapping method by using the extended base address register identifier as an input parameter, to obtain an address of the extended base address register space of the target virtual device; and access the address of the extended base address register space to obtain the virtualization mapping information.

In an embodiment of the present disclosure, before obtaining the extended base address register identifier of the target virtual device, the obtaining module 31 is further configured to: create the target virtual device by calling a device driver of the target physical device, where an extended base address register identifier of the target virtual device is set in the device driver; and when obtaining the extended base address register identifier of the target virtual device, the obtaining module 31 is specifically configured to: obtain the extended base address register identifier of the target virtual device based on the device driver or the target virtual device.

In an embodiment of the present disclosure, the obtaining module 31 is further configured to: receive a configuration instruction sent by the virtual machine host, where the configuration instruction comprises the virtualization mapping information; and write, in response to the configuration instruction, the virtualization mapping information into the extended base address register space of the target virtual device.

In an embodiment of the present disclosure, the operation module 32 is specifically configured to: convert, based on the virtualization mapping information, the first operation request into a second operation request for the target physical device; and send the second operation request to the target physical device, to operate the target physical device and obtain the operation result returned by the target physical device.

In an embodiment of the present disclosure, the virtualization mapping information includes first mapping information, and the first mapping information is used to represent a mapping relationship between a direct memory access address of operation data in the virtual machine client and a direct memory access address of the operation data in the virtual machine host; and when converting, based on the virtualization mapping information, the first operation request into the second operation request for the target physical device, the operation module 32 is specifically configured to: obtain a first direct memory access address of target operation data corresponding to the first operation request; obtain, based on the first mapping information, a second direct memory access address corresponding to the first direct memory access address; and generate the second operation request based on the second direct memory access address.

In an embodiment of the present disclosure, the virtualization mapping information includes second mapping information, and the second mapping information is used to represent a mapping relationship between a logical block address of the virtual device and a logical block address of the physical device; and the operation module 32 is further configured to: obtain a first logical block address of the target virtual device; and obtain a second logical block address of the target physical device based on the second mapping information; and when generating the second operation request based on the second direct memory access address, the operation module 32 is specifically configured to: generate the second operation request based on the second direct memory access address and the second logical block address.

In an embodiment of the present disclosure, the first mapping information includes input/output memory management unit address mapping; and when obtaining, based on the first mapping information, the second direct memory access address corresponding to the first direct memory access address, the operation module 32 is specifically configured to: generate virtual input/output memory management unit address mapping based on the input/output memory management unit address mapping; and obtain the second direct memory access address corresponding to the first direct memory access address based on the virtual input/output memory management unit address mapping.

In an embodiment of the present disclosure, the virtualization mapping information includes third mapping information, and the third mapping information is used to represent a mapping relationship between a queue identifier of the physical device and a queue identifier of the virtual device; and the operation module 32 is further configured to: obtain a first queue identifier of a target virtual read/write submission queue corresponding to the first operation request; obtain a second queue identifier of a physical read/write submission queue of the target physical device based on the third mapping information and the first queue identifier; and when sending the second operation request to the target physical device, to operate the target physical device and obtain the operation result returned by the target physical device, the operation module 32 is specifically configured to: determine a target physical read/write submission queue of the target physical device based on the second queue identifier; send the second operation request to the target physical read/write submission queue of the target physical device; and after the target physical read/write submission queue responds to the second operation request, receive an operation result returned by a target physical read/write completion queue of the target physical device, and store the operation result in a virtual read/write completion queue corresponding to the virtual read/write submission queue.

The obtaining module 31 is connected to the operation module 32. The storage device control apparatus 3 provided in this embodiment can perform the technical solution in the foregoing method embodiment, the implementation principles and technical effects thereof are similar, and are not described herein again in this embodiment.

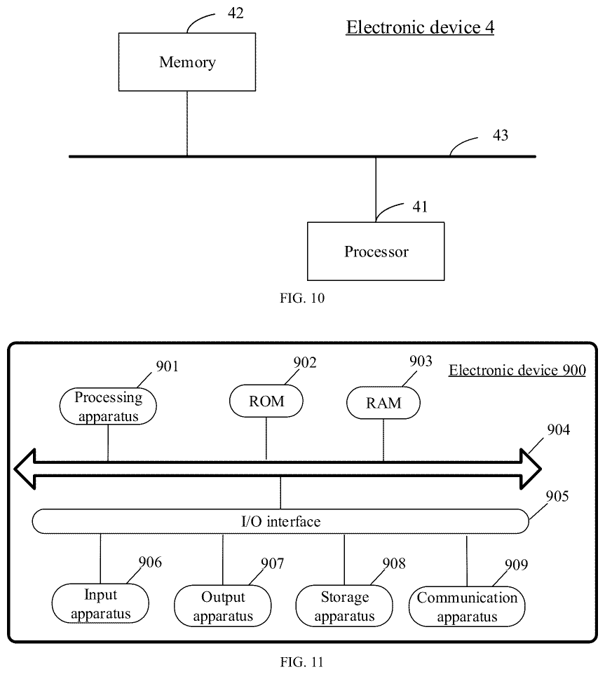

FIG. 10 is a structural schematic diagram of an electronic device according to an embodiment of the present disclosure. As shown in FIG. 10, the electronic device 4 includes:
a processor 41 and a memory 42 communicatively connected to the processor 41;
the memory 42 stores a computer-executable instruction; and
the processor 41 executes the computer-executable instruction stored in the memory 42, to implement the storage device control methods in the embodiments shown in FIG. 2 to FIG. 8.

In an implementation, the processor 41 and the memory 42 are connected through a bus 43.

For related descriptions, reference may be made to corresponding descriptions and effects of the steps in the embodiments corresponding to FIG. 2 to FIG. 8 for understanding, which is not described herein again.

An embodiment of the present disclosure provides a computer-readable storage medium. The computer-readable storage medium stores a computer-executable instruction. When the computer-executable instruction is executed by a processor, the storage device control method provided in any one of the embodiments corresponding to FIG. 2 to FIG. 8 of the present disclosure is implemented.

To implement the foregoing embodiments, an embodiment of the present disclosure further provides an electronic device.

With reference to FIG. 11, FIG. 11 is a structural schematic diagram of an electronic device 900 suitable for implementing an embodiment of the present disclosure. The electronic device 900 may be a terminal device or a server. The terminal device may include, but is not limited to, a mobile terminal such as a mobile phone, a notebook computer, a digital broadcast receiver, a personal digital assistant (PDA), a portable android device (PAD), a portable media player (PMP), and a vehicle-mounted terminal (for example, a vehicle navigation terminal), and a fixed terminal such as a digital TV, a desktop computer, and the like. The electronic device shown in FIG. 11 is merely an example, and shall not impose any limitation on the function and scope of use of the embodiments of the present disclosure.

As shown in FIG. 11, the electronic device 900 may include a processing apparatus (for example, a central processing unit, a graphics processing unit, etc.) 901 that may perform a variety of appropriate actions and processing in accordance with a program stored in a read-only memory (ROM) 902 or a program loaded from a storage apparatus 908 into a random access memory (RAM) 903. The RAM 903 further stores various programs and data required for the operation of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touch screen, a touchpad, a keyboard, a mouse, a camera, a microphone, an accelerometer, and a gyroscope; an output apparatus 907 including, for example, a liquid crystal display (LCD), a speaker, and a vibrator; the storage apparatus 908 including, for example, a tape and a hard disk; and a communication apparatus 909. The communication apparatus 909 may allow the electronic device 900 to perform wireless or wired communication with other devices to exchange data. Although FIG. 11 shows the electronic device 900 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 909, or installed from the storage apparatus 908, or installed from the ROM 902. When the computer program is executed by the processing apparatus 901, the above-mentioned functions defined in the methods of the embodiments of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, where the computer-readable program code is carried. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

The above computer-readable medium may be contained in the above electronic device. Alternatively, the computer-readable medium may exist independently, without being assembled into the electronic device.

The above computer-readable medium carries one or more programs, and when the one or more programs are executed by the electronic device, the electronic device is enabled to execute the methods shown in the above embodiments.

The computer program code for performing the operations in the present disclosure can be written in one or more programming languages or a combination thereof, where the programming languages include an object-oriented programming language, for example, Java, Smalltalk, and C++, and further include conventional procedural programming languages, for example, “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, and may also be implemented by means of hardware. The name of a unit does not constitute a limitation on the unit itself in some cases. For example, a first obtaining unit may also be described as “a unit for obtaining at least two Internet protocol addresses”.

The functions described above herein may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on a chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

In a first aspect, according to one or more embodiments of the present disclosure, there is provided a storage device control method, including:
obtaining virtualization mapping information of a target physical device by accessing an extended base address register space, where the virtualization mapping information is used to implement a pass-through connection between a virtual machine client and the target physical device, and the target physical device is a storage device that is mounted on a virtual machine host corresponding to the virtual machine client; and operating, based on the virtualization mapping information, the target physical device in response to a first operation request for a target virtual device, to obtain an operation result, where the target virtual device is a virtualization device corresponding to the target physical device and created in the virtual machine client.

According to one or more embodiments of the present disclosure, the obtaining virtualization mapping information of a target physical device by accessing an extended base address register space includes: obtaining an extended base address register identifier of the target virtual device; and accessing the extended base address register space of the target virtual device based on the extended base address register identifier, to obtain the virtualization mapping information.

According to one or more embodiments of the present disclosure, the accessing the extended base address register space of the target virtual device based on the extended base address register identifier, to obtain the virtualization mapping information includes: calling an input/output remapping method by using the extended base address register identifier as an input parameter, to obtain an address of the extended base address register space of the target virtual device; and accessing the address of the extended base address register space to obtain the virtualization mapping information.

According to one or more embodiments of the present disclosure, before the obtaining an extended base address register identifier of the target virtual device, the method further includes: creating the target virtual device by calling a device driver of the target physical device, where an extended base address register identifier of the target virtual device is set in the device driver; and the obtaining an extended base address register identifier of the target virtual device includes: obtaining the extended base address register identifier of the target virtual device based on the device driver or the target virtual device.

According to one or more embodiments of the present disclosure, the method further includes: receiving a configuration instruction sent by the virtual machine host, where the configuration instruction comprises the virtualization mapping information; and writing, in response to the configuration instruction, the virtualization mapping information into the extended base address register space of the target virtual device.

According to one or more embodiments of the present disclosure, the operating, based on the virtualization mapping information, the target physical device in response to a first operation request for a target virtual device, to obtain an operation result includes: converting, based on the virtualization mapping information, the first operation request into a second operation request for the target physical device; and sending the second operation request to the target physical device, to operate the target physical device and obtain the operation result returned by the target physical device.

According to one or more embodiments of the present disclosure, the virtualization mapping information includes first mapping information, and the first mapping information is used to represent a mapping relationship between a direct memory access address of operation data in the virtual machine client and a direct memory access address of the operation data in the virtual machine host; and the converting, based on the virtualization mapping information, the first operation request into a second operation request for the target physical device includes: obtaining a first direct memory access address of target operation data corresponding to the first operation request; obtaining, based on the first mapping information, a second direct memory access address corresponding to the first direct memory access address; and generating the second operation request based on the second direct memory access address.

According to one or more embodiments of the present disclosure, the virtualization mapping information includes second mapping information, and the second mapping information is used to represent a mapping relationship between a logical block address of the virtual device and a logical block address of the physical device; and the method further includes: obtaining a first logical block address of the target virtual device; and obtaining a second logical block address of the target physical device based on the second mapping information; and the generating the second operation request based on the second direct memory access address includes: generating the second operation request based on the second direct memory access address and the second logical block address.

According to one or more embodiments of the present disclosure, the first mapping information includes input/output memory management unit address mapping; and the obtaining, based on the first mapping information, a second direct memory access address corresponding to the first direct memory access address includes: generating virtual input/output memory management unit address mapping based on the input/output memory management unit address mapping; and obtaining the second direct memory access address corresponding to the first direct memory access address based on the virtual input/output memory management unit address mapping.

According to one or more embodiments of the present disclosure, the virtualization mapping information includes third mapping information, and the third mapping information is used to represent a mapping relationship between a queue identifier of the physical device and a queue identifier of the virtual device; and the method further includes: obtaining a first queue identifier of a target virtual read/write submission queue corresponding to the first operation request; obtaining a second queue identifier of a physical read/write submission queue of the target physical device based on the third mapping information and the first queue identifier; and the sending the second operation request to the target physical device, to operate the target physical device and obtain the operation result returned by the target physical device includes: determining a target physical read/write submission queue of the target physical device based on the second queue identifier; sending the second operation request to the target physical read/write submission queue of the target physical device; and after the target physical read/write submission queue responds to the second operation request, receiving an operation result returned by a target physical read/write completion queue of the target physical device, and storing the operation result in a virtual read/write completion queue corresponding to the virtual read/write submission queue.

According to a second aspect, according to one or more embodiments of the present disclosure, there is provided a storage device control apparatus, including:
an obtaining module, configured to obtain virtualization mapping information of a target physical device by accessing an extended base address register space, where the virtualization mapping information is used to implement a pass-through connection between a virtual machine client and the target physical device, and the target physical device is a storage device that is mounted on a virtual machine host corresponding to the virtual machine client; and
an operation module, configured to operate, based on the virtualization mapping information, the target physical device in response to a first operation request for a target virtual device, to obtain an operation result, where the target virtual device is a virtualization device corresponding to the target physical device and created in the virtual machine client.

According to one or more embodiments of the present disclosure, the obtaining module is specifically configured to: obtain an extended base address register identifier of the target virtual device; and access the extended base address register space of the target virtual device based on the extended base address register identifier, to obtain the virtualization mapping information.

According to one or more embodiments of the present disclosure, when accessing the extended base address register space of the target virtual device based on the extended base address register identifier, to obtain the virtualization mapping information, the obtaining module is specifically configured to: call an input/output remapping method by using the extended base address register identifier as an input parameter, to obtain an address of the extended base address register space of the target virtual device; and access the address of the extended base address register space to obtain the virtualization mapping information.

According to one or more embodiments of the present disclosure, before obtaining the extended base address register identifier of the target virtual device, the obtaining module is further configured to: create the target virtual device by calling a device driver of the target physical device, where an extended base address register identifier of the target virtual device is set in the device driver; and when obtaining the extended base address register identifier of the target virtual device, the obtaining module is specifically configured to: obtain the extended base address register identifier of the target virtual device based on the device driver or the target virtual device.

According to one or more embodiments of the present disclosure, the obtaining module is further configured to: receive a configuration instruction sent by the virtual machine host, where the configuration instruction comprises the virtualization mapping information; and write, in response to the configuration instruction, the virtualization mapping information into the extended base address register space of the target virtual device.

According to one or more embodiments of the present disclosure, the operation module is specifically configured to: convert, based on the virtualization mapping information, the first operation request into a second operation request for the target physical device; and send the second operation request to the target physical device, to operate the target physical device and obtain the operation result returned by the target physical device.

According to one or more embodiments of the present disclosure, the virtualization mapping information includes first mapping information, and the first mapping information is used to represent a mapping relationship between a direct memory access address of operation data in the virtual machine client and a direct memory access address of the operation data in the virtual machine host; and when converting, based on the virtualization mapping information, the first operation request into the second operation request for the target physical device, the operation module is specifically configured to: obtain a first direct memory access address of target operation data corresponding to the first operation request; obtain, based on the first mapping information, a second direct memory access address corresponding to the first direct memory access address; and generate the second operation request based on the second direct memory access address.

According to one or more embodiments of the present disclosure, the virtualization mapping information includes second mapping information, and the second mapping information is used to represent a mapping relationship between a logical block address of the virtual device and a logical block address of the physical device; and the operation module is further configured to: obtain a first logical block address of the target virtual device; and obtain a second logical block address of the target physical device based on the second mapping information; and when generating the second operation request based on the second direct memory access address, the operation module is specifically configured to: generate the second operation request based on the second direct memory access address and the second logical block address.

According to one or more embodiments of the present disclosure, the first mapping information includes input/output memory management unit address mapping; and when obtaining, based on the first mapping information, the second direct memory access address corresponding to the first direct memory access address, the operation module is specifically configured to: generate virtual input/output memory management unit address mapping based on the input/output memory management unit address mapping; and obtain the second direct memory access address corresponding to the first direct memory access address based on the virtual input/output memory management unit address mapping.

According to one or more embodiments of the present disclosure, the virtualization mapping information includes third mapping information, and the third mapping information is used to represent a mapping relationship between a queue identifier of the physical device and a queue identifier of the virtual device; and the operation module is further configured to: obtain a first queue identifier of a target virtual read/write submission queue corresponding to the first operation request; obtain a second queue identifier of a physical read/write submission queue of the target physical device based on the third mapping information and the first queue identifier; and when sending the second operation request to the target physical device, to operate the target physical device and obtain the operation result returned by the target physical device, the operation module is specifically configured to: determine a target physical read/write submission queue of the target physical device based on the second queue identifier; send the second operation request to the target physical read/write submission queue of the target physical device; and after the target physical read/write submission queue responds to the second operation request, receive an operation result returned by a target physical read/write completion queue of the target physical device, and store the operation result in a virtual read/write completion queue corresponding to the virtual read/write submission queue.

According to a third aspect, according to one or more embodiments of the present disclosure, there is provided an electronic device, including: at least one processor and a memory;
the memory stores a computer-executable instruction; and
the at least one processor executes the computer-executable instruction stored in the memory, such that the at least one processor executes the storage device control methods according to the first aspect and the various possible designs of the first aspect.

According to a fourth aspect, according to one or more embodiments of the present disclosure, there is provided a computer-readable storage medium storing a computer-executable instruction that, when executed by a processor, implements the storage device control methods according to the first aspect and the various possible designs of the first aspect.

According to a fifth aspect, according to one or more embodiments of the present disclosure, there is provided a computer program product, including a computer program that, when executed by a processor, implements the storage device control methods according to the first aspect and the various possible designs of the first aspect.

The above descriptions are merely preferred embodiments of the present disclosure and explanations of the applied technical principles. A person skilled in the art should understand that the scope of disclosure involved in the present disclosure is not limited to the technical solution formed by a specific combination of the foregoing technical features, and shall also cover other technical solutions formed by any combination of the foregoing technical features or their equivalent features without departing from the foregoing concept of disclosure, for example, a technical solution formed by replacing the foregoing features with technical features having similar functions disclosed in the present disclosure (but not limited thereto).

In addition, although various operations are depicted in a specific order, it should not be understood as requiring these operations to be performed in the specific order shown or in a sequential order. Under specific circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment can also be implemented in a plurality of embodiments individually or in any suitable subcombination.

Although the subject matter has been described in language specific to structural features and/or logical actions of the method, it should be understood that the subject matter defined in the appended claims is not necessarily limited to the specific features or actions described above. In contrast, the specific features and actions described above are merely exemplary forms of implementing the claims.

What is claimed is:

1. A storage device control method, comprising:
obtaining virtualization mapping information of a target physical device by accessing an extended base address register space, wherein the virtualization mapping information is used to implement a pass-through connection between a virtual machine client and the target physical device, and the target physical device is a storage device that is mounted on a virtual machine host corresponding to the virtual machine client; and
operating, based on the virtualization mapping information, the target physical device in response to a first operation request for a target virtual device to obtain an operation result, wherein the target virtual device is a virtualization device corresponding to the target physical device and created in the virtual machine client.

2. The method according to claim 1, wherein the obtaining virtualization mapping information of a target physical device by accessing an extended base address register space comprises:
obtaining an extended base address register identifier of the target virtual device; and
accessing the extended base address register space of the target virtual device based on the extended base address register identifier, to obtain the virtualization mapping information.

3. The method according to claim 2, wherein the accessing the extended base address register space of the target virtual device based on the extended base address register identifier, to obtain the virtualization mapping information comprises:
calling an input/output remapping method by using the extended base address register identifier as an input parameter, to obtain an address of the extended base address register space of the target virtual device; and
accessing the address of the extended base address register space to obtain the virtualization mapping information.

4. The method according to claim 2, wherein before the obtaining an extended base address register identifier of the target virtual device, the method further comprises:
creating the target virtual device by calling a device driver of the target physical device, wherein an extended base address register identifier of the target virtual device is set in the device driver; and
the obtaining an extended base address register identifier of the target virtual device comprises:
obtaining the extended base address register identifier of the target virtual device based on the device driver or the target virtual device.

5. The method according to claim 3, wherein before the obtaining an extended base address register identifier of the target virtual device, the method further comprises:
creating the target virtual device by calling a device driver of the target physical device, wherein an extended base address register identifier of the target virtual device is set in the device driver; and
the obtaining an extended base address register identifier of the target virtual device comprises:
obtaining the extended base address register identifier of the target virtual device based on the device driver or the target virtual device.

6. The method according to claim 1, wherein the method further comprises:
receiving a configuration instruction sent by the virtual machine host, wherein the configuration instruction comprises the virtualization mapping information; and
writing, in response to the configuration instruction, the virtualization mapping information into the extended base address register space of the target virtual device.

7. The method according to claim 2, wherein the method further comprises:
receiving a configuration instruction sent by the virtual machine host, wherein the configuration instruction comprises the virtualization mapping information; and
writing, in response to the configuration instruction, the virtualization mapping information into the extended base address register space of the target virtual device.

8. The method according to claim 3, wherein the method further comprises:
receiving a configuration instruction sent by the virtual machine host, wherein the configuration instruction comprises the virtualization mapping information; and
writing, in response to the configuration instruction, the virtualization mapping information into the extended base address register space of the target virtual device.

9. The method according to claim 4, wherein the method further comprises:
receiving a configuration instruction sent by the virtual machine host, wherein the configuration instruction comprises the virtualization mapping information; and
writing, in response to the configuration instruction, the virtualization mapping information into the extended base address register space of the target virtual device.

10. The method according to claim 5, wherein the method further comprises:
receiving a configuration instruction sent by the virtual machine host, wherein the configuration instruction comprises the virtualization mapping information; and
writing, in response to the configuration instruction, the virtualization mapping information into the extended base address register space of the target virtual device.

11. The method according to claim 1, wherein the operating, based on the virtualization mapping information, the target physical device in response to a first operation request for a target virtual device, to obtain an operation result comprises:
converting, based on the virtualization mapping information, the first operation request into a second operation request for the target physical device; and
sending the second operation request to the target physical device, to operate the target physical device and obtain the operation result returned by the target physical device.

12. The method according to claim 2, wherein the operating, based on the virtualization mapping information, the target physical device in response to a first operation request for a target virtual device, to obtain an operation result comprises:
converting, based on the virtualization mapping information, the first operation request into a second operation request for the target physical device; and
sending the second operation request to the target physical device, to operate the target physical device and obtain the operation result returned by the target physical device.

13. The method according to claim 3, wherein the operating, based on the virtualization mapping information, the target physical device in response to a first operation request for a target virtual device, to obtain an operation result comprises:
converting, based on the virtualization mapping information, the first operation request into a second operation request for the target physical device; and
sending the second operation request to the target physical device, to operate the target physical device and obtain the operation result returned by the target physical device.

14. The method according to claim 4, wherein the operating, based on the virtualization mapping information, the target physical device in response to a first operation request for a target virtual device, to obtain an operation result comprises:
converting, based on the virtualization mapping information, the first operation request into a second operation request for the target physical device; and
sending the second operation request to the target physical device, to operate the target physical device and obtain the operation result returned by the target physical device.

15. The method according to claim 11, wherein the virtualization mapping information comprises first mapping information, and the first mapping information is used to represent a mapping relationship between a direct memory access address of operation data in the virtual machine client and a direct memory access address of the operation data in the virtual machine host; and
the converting, based on the virtualization mapping information, the first operation request into a second operation request for the target physical device comprises:
obtaining a first direct memory access address of target operation data corresponding to the first operation request;
obtaining, based on the first mapping information, a second direct memory access address corresponding to the first direct memory access address; and
generating the second operation request based on the second direct memory access address.

16. The method according to claim 15, wherein the virtualization mapping information comprises second mapping information, and the second mapping information is used to represent a mapping relationship between a logical block address of the virtual device and a logical block address of the physical device; and the method further comprises:
obtaining a first logical block address of the target virtual device; and
obtaining a second logical block address of the target physical device based on the second mapping information,
wherein the generating the second operation request based on the second direct memory access address comprises:
generating the second operation request based on the second direct memory access address and the second logical block address.

17. The method according to claim 15, wherein the first mapping information comprises input/output memory management unit address mapping; and
the obtaining, based on the first mapping information, a second direct memory access address corresponding to the first direct memory access address comprises:
generating virtual input/output memory management unit address mapping based on the input/output memory management unit address mapping; and
obtaining the second direct memory access address corresponding to the first direct memory access address based on the virtual input/output memory management unit address mapping.

18. The method according to claim 11, wherein the virtualization mapping information comprises third mapping information, and the third mapping information is used to represent a mapping relationship between a queue identifier of the physical device and a queue identifier of the virtual device; and the method further comprises:
obtaining a first queue identifier of a target virtual read/write submission queue corresponding to the first operation request; and
obtaining a second queue identifier of a physical read/write submission queue of the target physical device based on the third mapping information and the first queue identifier,
wherein the sending the second operation request to the target physical device, to operate the target physical device and obtain the operation result returned by the target physical device comprises:
determining a target physical read/write submission queue of the target physical device based on the second queue identifier;
sending the second operation request to the target physical read/write submission queue of the target physical device; and
after the target physical read/write submission queue responds to the second operation request, receiving an operation result returned by a target physical read/write completion queue of the target physical device, and storing the operation result in a virtual read/write completion queue corresponding to the virtual read/write submission queue.

19. An electronic device, comprising: a processor and a memory;
wherein the memory stores a computer-executable instruction; and
the processor executes the computer-executable instruction stored in the memory, such that the at least one processor is enabled to:
obtain virtualization mapping information of a target physical device by accessing an extended base address register space, wherein the virtualization mapping information is used to implement a pass-through connection between a virtual machine client and the target physical device, and the target physical device is a storage device that is mounted on a virtual machine host corresponding to the virtual machine client; and
operate, based on the virtualization mapping information, the target physical device in response to a first operation request for a target virtual device, to obtain an operation result, wherein the target virtual device is a virtualization device corresponding to the target physical device and created in the virtual machine client.

20. A non-transitory computer-readable storage medium, wherein the computer-readable storage medium stores a computer-executable instruction, and when a processor executes the computer-executable instruction, the computer-executable instruction enables a computing device to:
obtain virtualization mapping information of a target physical device by accessing an extended base address register space, wherein the virtualization mapping information is used to implement a pass-through connection between a virtual machine client and the target physical device, and the target physical device is a storage device that is mounted on a virtual machine host corresponding to the virtual machine client; and
operate, based on the virtualization mapping information, the target physical device in response to a first operation request for a target virtual device, to obtain an operation result, wherein the target virtual device is a virtualization device corresponding to the target physical device and created in the virtual machine client.
